(19) United States
(12) Patent Application Publication
(10) Pub. No.: US 2012/0092529 A1
(43) Pub. Date: Apr. 19, 2012

(54) METHOD FOR PROCESSING AN IMAGE AND AN IMAGE PHOTOGRAPHING APPARATUS APPLYING THE SAME

(75) Inventors: Song-ha CHOI, Anyang-si (KR); Young-jae Yoo, Hwaseong-si (KR)

(73) Assignee: Samsung Electronics Co., Ltd., Suwon-si (KR)

(21) Appl. No.: 13/267,949

(22) Filed: Oct. 7, 2011

(30) Foreign Application Priority Data
Oct. 19, 2010 (KR) 2010-0102127

(51) Int. Cl. H04N 5/262

(52) U.S. Cl. 348/239; 348/E05.056

(57) ABSTRACT

A method of processing an image and an image photographing apparatus applying the same. The image processing method includes obtaining a main image and a sub image from the first lens and the second lens respectively, detecting a main object of the main image, moving the sub image to a first area of the main image so as not to be overlapped with the main object of the main image, and displaying the main image and the sub image therein simultaneously. Accordingly, a user may view the main image without any interference of the sub image displayed on a display unit.

### CROSS-REFERENCE TO RELATED APPLICATIONS

This application claims the benefit of priority under 35 U.S.C. §119 to Korean Patent Application No. 10-2010-0102127, filed in the Korean Intellectual Property Office on Oct. 19, 2010, the contents of which are incorporated herein by reference in its entirety.

### BACKGROUND OF THE INVENTION

1. Field of the Invention

The present general inventive concept relates to a method for processing an image and an image photographing apparatus using the method, and more particularly, to a method for processing a main image and a sub image which are photographed using a plurality of lenses and an image photographing apparatus using the method.

2. Description of the Related Art

Most of the recent image photographing apparatuses (for example, a digital camera, a camcorder, and so on) include a view finder which displays a subject being photographed so that a user may view an image being photographed through the view finder of the image photographing apparatus.

In particular, if the image photographing apparatus comprises a plurality of lenses, a main image photographed by one lens is displayed on the view finder and a sub image, photographed by another lens and synthesized with the main image as a picture in picture (PIP) image, is also displayed on the view finder.

As the main image and the sub image synthesized with the main image as a PIP image are displayed simultaneously, a user may check both the main image and the sub image and photograph one of the images.

As the main image and the sub image are displayed simultaneously, the user has the advantage of viewing various images at the same time. However, if the sub image displayed as a PIP image blocks a main object in the main image, the user may not view the main object appropriately.

However, recent image photographing apparatuses do not provide a method for processing the main image and the sub image such that the user can view the main image appropriately in the case where the sub image blocks a main object in the main image.

Meanwhile, in some cases, a user may wish to not only check the main image and the sub image and photograph one of the images, but also to create a new image using the main image and the sub image.

However, recent image photographic apparatuses do not provide a method for processing an image in order to provide a new image created using a main image and a sub image to a user.

### SUMMARY OF THE INVENTION

The present general inventive concept provides a method for processing an image in which, if a main object in a main image is overlapped with a sub image, the sub image is relocated so as not to be overlapped with the main object in the main image and an image photographing apparatus applying the same.

The present general inventive concept also provides a method for processing an image in which an object is extracted from a sub image and the extracted object is synthesized with a specific area of a main image and an image photographing apparatus applying the same.

Additional aspects and advantages of the present general inventive concept will be set forth in part in the description which follows and, in part, will be obvious from the description, or may be learned by practice of the general inventive concept.

Features and/or utilities of the present general inventive concept may be realized by a method of processing an image in an image photographing apparatus having a first lens and a second lens, wherein the method includes obtaining a main image and a sub image from the first lens and the second lens respectively, detecting a main object of the main image, moving the sub image to a first area of the main image so as not to be overlapped with the main object of the main image, and displaying the main image and displaying the sub image in the first area of the main image simultaneously.

The detecting may include recognizing a face of a person to be photographed who is included in the main image obtained from the first lens and detecting a specific area including the recognized face as the main object.

The detecting may include recognizing a focus of the main image obtained from the first lens and detecting a specific area which is in focus as the main object.

The sub image may be a Picture-in-Picture (PIP) image.

The first lens may be disposed in a front side of the image photographing apparatus and the second lens may be disposed in a back side of the image photographing apparatus.

Features and/or utilities of the present general inventive concept may also be realized by an image photographing apparatus which includes a first lens unit which photographs a main image, a second lens unit which photographs a sub image, a detection unit which detects a main object of the main image, an image conversion unit which moves the sub image to a first area of the main image so as not to be overlapped with the main object of the main image, and an image display unit which displays the main image and displays the sub image in the first area of the main image simultaneously.

The detection unit may include a face recognition unit which recognizes a face of a person to be photographed who is included in the main image obtained from the first lens unit, and the detection unit may detect a specific area including the recognized face as the main object of the main image.

The detection unit may include a face recognition unit which recognizes a focus of the main image obtained from the first lens, and the detection unit may detect a specific area which is in focus as the main object of the main image.

The sub image may be a PIP image.

The first lens may be disposed in a front side of the image photographing apparatus and the second lens may be disposed in a back side of the image photographing apparatus.

Features and/or utilities of the present general inventive concept may also be realized by a method of processing an image in an image photographing apparatus having a first lens and a second lens, wherein the method includes obtaining a main image and a sub image from the first lens and the second lens respectively, detecting an object of the sub image, moving the object of the sub image to a first area of the main image and synthesizing the object of the sub image with the first area of the main image, and displaying the main image with which the object of the sub image is synthesized.

The detecting may include recognizing a face of a photographer included in the sub image obtained from the second lens and detecting a specific area including the recognized face as the object of the sub image.

The first area may be a specific area including a face of a person to be photographed who is recognized in the main image obtained from the first lens unit, and the synthesizing may include synthesizing the face of the photographer with the face of the person to be photographed.

The sub image may have a single-color background, and the synthesizing may include chroma-key synthesizing the object of the sub image with the first area of the main image.

The sub image may be a PIP image.

The second lens may be disposed on an opposite side from the first lens to photograph a photographer of the image photographing apparatus.

Features and/or utilities of the present general inventive concept may also be realized by an image photographing apparatus which includes a first lens unit which photographs a main image, a second lens unit which photographs a sub image, a detection unit which detects an object included En the sub image, an image conversion unit which moves the object of the sub image to a first area of the main image and synthesizes the object of the sub image with the first area of the main image, and an image display unit which displays the main image with which the object of the sub image is synthesized.

The detection unit may include a face recognition unit which recognizes a face of a photographer included in the sub image obtained from the second lens, and the detection unit may include detecting a specific area including the recognized face as the object of the sub image.

The first area may be a specific area including a face of a person to be photographed who is recognized in the main image obtained from the first lens, and the image conversion unit may synthesize the face of the photographer with the face of the person to be photographed.

The sub image may have a single-color background, and the image conversion unit may chroma-key synthesize the object of the sub image with the first area of the main image.

The sub image may be a PIP image.

The second lens may be disposed on an opposite side from the first lens to photograph a photographer of the image photographing apparatus.

Features and/or utilities of the present general inventive concept may also be realized by a method of processing an image in an image photographing apparatus having a first lens and a second lens, wherein the method includes obtaining a main image and a sub image from the first lens and the second lens respectively, detecting a first object in the main image and a second object in the sub image, replacing the first object of the main image with the second object of the sub image, and displaying the main image in which the second object of the sub image has replaced the first object of the main image.

The replacing the first object of the main image with the second object of the sub image may include moving the second object to a location of the first object and resizing the second object to a size that is substantially the same as a size of the first object.

The detecting the first object of the main image and the second object of the sub image may include detecting an image of a face of a first person as the first object and detecting an image of a face of a second person as the second object.

The first lens and the second lens may be disposed on opposite sides of the image photographing apparatus.

Features and/or utilities of the present general inventive concept may also be realized by a method of processing an image in an image photographing apparatus having a first lens and a second lens, wherein the method includes, obtaining a main image and a sub image from the first lens and the second lens respectively, detecting a first object in the main image and a second object in the sub image, performing at least one of operations of moving the sub image to a first area of the main image so as not to be overlapped with the first object of the main image, moving the second object of the sub image to a second area of the main image and synthesizing the second object of the sub image with the second area of the main image, and replacing the first object of the main image with the second object of the sub image, and displaying a new image corresponding to the at least one performed operation.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an image photographing apparatus briefly according to an exemplary embodiment of the present general inventive concept;

FIG. 2 is a block diagram illustrating an image photographing apparatus in detail according to an exemplary embodiment of the present general inventive concept;

FIG. 3 is a view to explain a method for processing an image in which a PIP image is relocated so as not to be overlapped with a face recognized in a main image according to an exemplary embodiment of the present general inventive concept;

FIG. 4 is a view to explain a method for processing an image in which a PIP image is relocated so as not to be overlapped with a focus area of a main image according to an exemplary embodiment of the present general inventive concept;

FIGS. 5A to 5C are views to explain a method for processing an image in which a face recognized in a PIP image is synthesized with a face recognized in a main image according to an exemplary embodiment of the present general inventive concept;

FIGS. 6A to 6C are views to explain a method for processing an image in which a PIP image is synthesized with a main image using a chroma-key composite method according to an exemplary embodiment of the present general inventive concept;

FIG. 7 is a flowchart to explain a method for processing an image in which a PIP image is relocated so as not to be overlapped with a main object in a main image according to an exemplary embodiment of the present general inventive concept; and

FIG. 8 is a flowchart to explain a method for processing an image in which an object of a sub image is synthesized with a main image according to an exemplary embodiment of the present general inventive concept.

FIG. 9 is a flowchart to explain a method for processing an image in which an object of the main image is replaced with an object of the sub image according to an exemplary embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to the like elements throughout. Exemplary embodiments are described below in order to explain the present general inventive concept by referring to the figures.

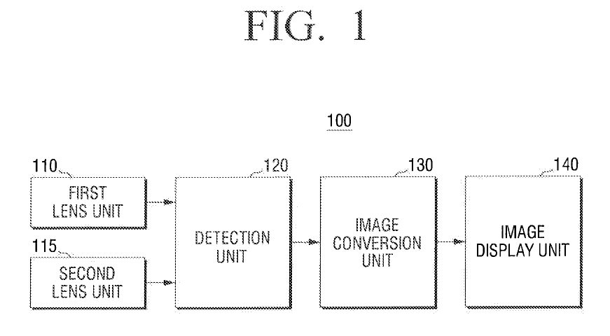

FIG. 1 is a block diagram illustrating an image photographing apparatus 100 briefly according to an exemplary embodiment.

As illustrated in FIG. 1, the image photographing apparatus 100 according to an exemplary embodiment comprises a first lens unit 110, a second lens unit 115, a detection unit 120, an image conversion unit 130, and an image display unit 140.

The first lens unit 110 and the second lens unit 115 collect light of a subject and photograph a main image and a sub image. The first lens unit 110 may be disposed on the front of the image photographing apparatus 100 and photograph the main image, and the second lens unit 120 may be disposed on the back of the image photographing apparatus 100 and photograph the sub image. The first lens unit 110 and the second lens unit 120 may photograph the main image and the sub image such that the main image and the sub image have different resolutions. For example, the main image may have a high resolution and the sub image may have a low resolution. Additionally, the sub image may be displayed on the image display unit 140 as a PIP image after being processed.

The detection unit 120 detects one or more objects in the main image and/or the sub image which are inputted through the first lens unit 110 and the second lens unit 115. For example, in order for a main object in the main image not to be overlapped with the sub image, the detection unit 120 detects the main object from the main image obtained through the first lens unit 110. The main object may be, for example, a face of a person to be photographed or a focus area included in the man image.

In addition, in order to composite an object in the sub image with the main image, the detection unit 120 detects an object from the sub image obtained through the second lens unit 115. For example, the object in the sub image may be a subject area excluding the face area of a photographer included in the sub image or may be a subject area excluding a background from a single-color image. In addition, the detection unit 120 may detect not only a face of a photographer included in the sub image but also a face of a person to be photographed included in the main image in order to composite the face of the photographer included in the sub image with the face of the person to be photographed included in the main image.

The image conversion unit 130 may convert an image using one or more objects detected by the detection unit 120. For example, if a main object in the main image detected by the detection unit 120 is overlapped with the sub image, the image conversion unit 130 may relocate the sub image so that the main object in the main image is not overlapped with the sub image.

In addition, if an object in the sub image detected by the detection unit 120 is synthesized with the main image, the image conversion unit 130 may move the object detected in the sub image to a composite area of the main image to composite the object in the sub image with the main image in the composite area.

The image display unit 140 displays the image converted by the image conversion unit 130. For example, the image display unit 140 may display a sub image which is relocated in order not to be overlapped with the main object in the main image along with the main image. If the main image and the sub image are processed according to the above description, the sub image is not overlapped with the main object in the main image and thus, a user may photograph the main image without any interference of the sub image displayed on the display unit.

As another example, the image display unit 140 may display the main image with which the object in the sub image is composted in the composite area of the main image. Thus, as the object in the sub image is synthesized with the main image, a photographer may obtain various images in addition to images acquired through a plurality of lenses.

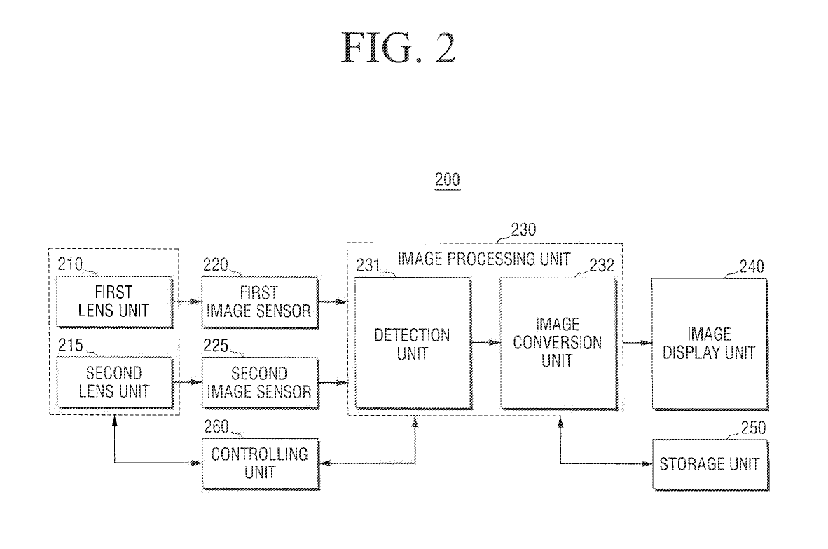

Hereinafter, the image photographing apparatus according to an exemplary embodiment will be explained in detail with reference to FIG. 2.

FIG. 2 is a block diagram illustrating the image photographing apparatus 200 in detail according to an exemplary embodiment.

As illustrated in FIG. 2, the image photographing apparatus 200 comprises a first lens unit 210, a second lens unit 215, a first image sensor 220, a second image sensor 225, an image processing unit 230, an image display unit 240, a storage unit 250, and a controlling unit 260.

The first lens unit 210 and the second lens unit 215 collect light and form an image on the area of the first image sensor 220 and the second image sensor 225 respectively. Herein, the first lens unit 210 and the second lens unit 216 may have different resolutions from each other. Specifically, the first lens unit 210 photographing the main image displayed on the image display unit 240 may photograph an image using a higher resolution than the sub image photographed by the second lens unit 215.

In addition, the first lens unit 210 may be disposed on the front of the image photographing apparatus 200 and photograph a subject disposed on the front of the image photographing apparatus 200. The second lens unit 215 may be disposed on the back of the image photographing apparatus 200 and photograph a subject disposed on the back of the image photographing apparatus 200. For example, if the second lens unit 215 is disposed on the back of the image photographing apparatus 200, the second lens unit 215 may photograph a photographer.

The first image sensor 220 and the second image sensor 225 photo-electrically convert light which enters through the first lens unit 210 and the second lens unit 215, respectively, to obtain images. Herein, the first image sensor 220 may obtain an image having a high resolution and the second image sensor 225 may obtain an image having a lower resolution compared to the image obtained by the first image sensor 220. For example, the main image obtained from the first lens unit 210 may be a high-resolution image having resolution higher than 10 megapixels, and the sub image obtained from the second lens unit 215 may be a low-resolution image having resolution of at least one of 1, 3 and 5 megapixels.

The image processing unit 230 performs signal-processing on the main image and the sub image inputted from the first image sensor 220 and the second image sensor 225, respectively, and transmits the processed image to the image display unit 240 to display the photographed image.

In particular, as illustrated in FIG. 2, the image processing unit 230 includes the detection unit 231 and the image conversion unit 232 to perform image processing on the main image and the sub image.

The detection unit 231 detects one or more objects from the main image and/or the sub image inputted from the first image sensor 220 and the second image sensor 225, respectively.

In particular, the detection unit 231 detects a main object in the main image such that it can be determined whether the main object in the main image is overlapped with the sub image. Herein, the main object may be a face area of a person to be photographed or a focus area which is included in the main image. In this case, the face area of the person to be photographed included in the main image is a specific area including a face detected through a known method of recognizing a face, and the focus area is an area of an object or a pattern including an area on which a camera is focused.

In addition, in order to composite the main image with an object in the sub image, the detection unit 231 detects an object in the sub image. For example, the object may be a subject area, excluding the face area, of a photographer included in the sub image. The object may also be a subject area excluding a background from a screen in a single color. In order to composite the face of a photographer included in the sub image with the face of a person to be photographed included in the main image, the object in the sub image may be an area including the face of the photographer included in the sub image. In this case, the area including the face of the photographer is a specific area including a face which is detected through a known method of recognizing a face. In the case of a chroma-key composite, the object in the sub image may be a subject area excluding a single-color background from the sub image.

The image conversion unit 232 may convert an image using one or more objects detected by the detection unit 231.

In particular, if the detection unit 231 determines that a detected main object in the main image is overlapped with the sub image, the image conversion unit 232 may relocate the sub image so that the main object in the main image is not overlapped with the sub image. For example, as described above with regard to the detection unit 231, if the face of a person who is recognized as a main object is located in the same position as the sub image and thus, is overlapped with the sub image, the image conversion unit 232 relocates the sub image so that the face of the recognized person is not overlapped with the sub image. In addition, the sub image may also be relocated so that a focus area which is recognized as a main object in the main image is not overlapped with the sub image.

In addition, if an object in the sub image detected by the detection unit 231 is synthesized with the main image, the image conversion unit 232 moves the object in the sub image to a composite area of the main image to composite the object in the sub image with the main image in the composite area. For example, if the face of a photographer is detected as an object in the sub image, the image conversion unit 232 moves the face area of the photographer in the sub image to the face area of a person to be photographed in the main image, enlarges the sub image, and composites the face area of the photographer with the face area of the person to be photographed in the main image.

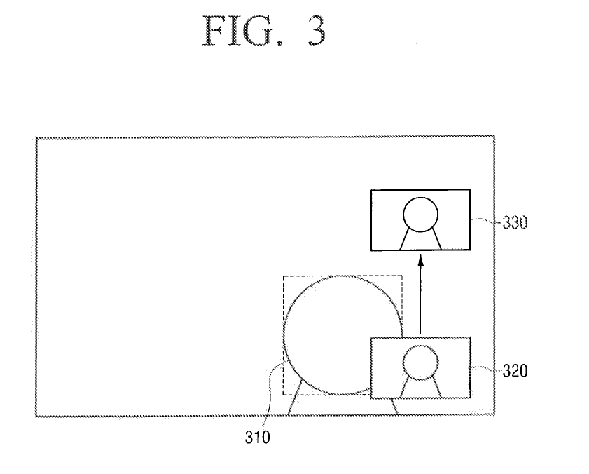

The method for converting an image by the image conversion unit 231 will be explained later with reference to FIGS. 3 to 6C.

The image display unit 240 displays an image received from the image processing unit 230. A user may check an image to be photographed by viewing an image displayed on the image display unit 240. In particular, the image display unit 240 regards an image photographed through the first lens unit 210 as the main image and an image photographed through the second lens unit 215 as the sub image, and displays the sub image on the main image in the form of a PIP image.

The storage unit 250 stores an image photographed by the first image sensor 220 and the second image sensor 225 in a compressed form. The storage unit 250 may be, for example, a non-volatile memory or a hard disk.

The controlling unit 260 identifies a user's command based on a user's manipulation transmitted from a manipulation unit (not shown), and controls the overall operation of the image photographing apparatus 200 according to the identified user's command.

Specifically, the controlling unit 260 determines whether a main object in the main image is overlapped with the sub image. If the main object is overlapped with the sub image, the controlling unit 260 controls the image conversion unit 232 to relocate the sub image so that the sub image is not overlapped with the main object in the main image. In this case, the main object may be the face area of a person to be photographed who is included in the main image or the focus area of the main image.

In addition, the controlling unit 260 may control the image conversion unit 232 to composite the main image with the sub image. Specifically, the controlling unit 260 may control the image conversion unit 232 to composite an object in the sub image with a composite area of the main image according to a user's command input through a manipulation unit. In this case, the object in the sub image may be the face area of a photographer included in the sub image or a subject area excluding a single-color background of the sub image. In addition, the composite area of the main image may be the face area of a person to be photographed who is included in the main image or an area designated by a user.

Hereinafter, a method for processing an image in which the main image and the sub image are converted will be explained with reference to FIGS. 3 to 6C.

FIG. 3 is a view to explain a method for processing an image in which a PIP image is relocated so as not to be overlapped with a face recognized in a main image according to an exemplary embodiment.

If the main image includes a face area 310 of a person to be photographed, and the face area 310 is overlapped with the PIP image 320, the image photographing apparatus 200 may relocate the PIP image 320 so that the PIP image 320 is not overlapped with the face area 310. For example, as illustrated in FIG. 3, if both the face area 310 and the PIP image 320 are displayed on the lower right, the PIP image 310 blocks the face area 310 which is the main object of the main image. Thus, a user may not view a screen that he or she wishes to photograph. Accordingly, the image photographing apparatus 200 moves the PIP image 320 from lower right to upper right so that the PIP image 330 is not overlapped with the face area 310. In this case, the image photographing apparatus 200 may detect the face area 310 of the main image through a known method of recognizing a face.

Accordingly, the moved PIP image 330 is not overlapped with the face area 310 and thus, the user may view the main object of the main image, which is the face area 310 of a person to be photographed, appropriately.

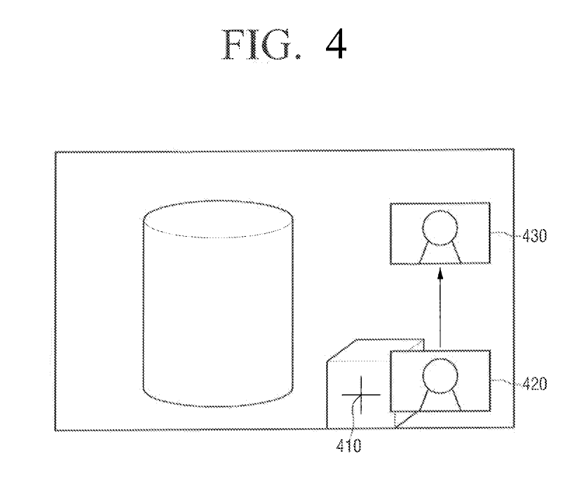

FIG. 4 is a view to explain a method for processing an image in which a PIP image is relocated so as not to be overlapped with a focus area of a main image according to an exemplary embodiment.

If the main image includes a focus area 410 of a person to be photographed, and the focus area 410 is overlapped with the PIP image 420, the image photographing apparatus 200 may relocate the PIP image 420 so that the PIP image 420 is not overlapped with the focus area 410. For example, as illustrated in FIG. 4, if both the focus area 410 and the PP image 420 are displayed on the lower right, the PIP image 410 blocks the focus area 410 which is the main object of the main image. Thus, a user may not view a screen that he or she wishes to photograph. Accordingly, the image photographing apparatus 200 moves the PIP image 420 from lower right to upper right so that the PIP image 430 is not overlapped with the face area 410. In this case, the focus area 410 of the main image may be an object area or a pattern area including an area on which a camera is focused.

Accordingly, the moved PIP image 430 is not overlapped with the focus area 410 and thus, a user may check whether the main image is into focus.

Furthermore, the direction in which a PIP image is moved may be a clockwise or a counter-clockwise direction with respect to each corner of the image display unit 240. For example, as illustrated in FIG. 3, if the main object 310 is overlapped with the PIP image 320 in the lower right of the image display unit 240, the image photographing apparatus 200 may move the PIP image 320 in a counter-clockwise direction to the upper right of the image display unit 240. Accordingly, if a main object and a PIP image overlap in the upper right of the image display unit 240, the PIP image may be moved in a counter-clockwise direction to the upper left of the image display unit 240 and so on.

However, moving a PIP image in a counter-clockwise direction is only an example, and the technical feature of the present invention may be applied when a PIP image moves in a clockwise direction or moves to an area furthest from the main object in the main image. In addition, the direction in which a PIP image moves may be set by a manufacturer or by a user.

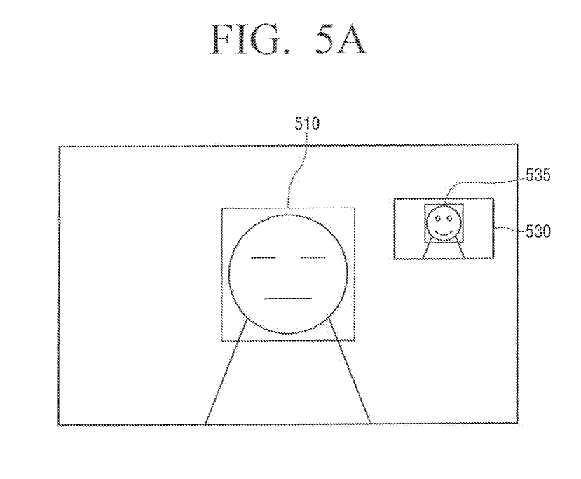

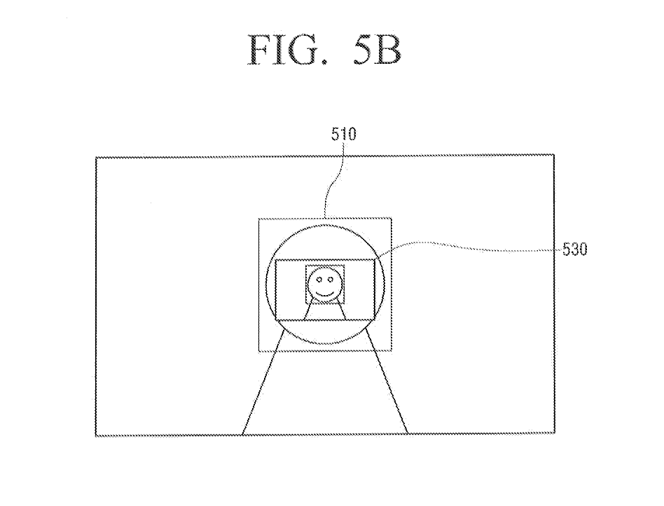

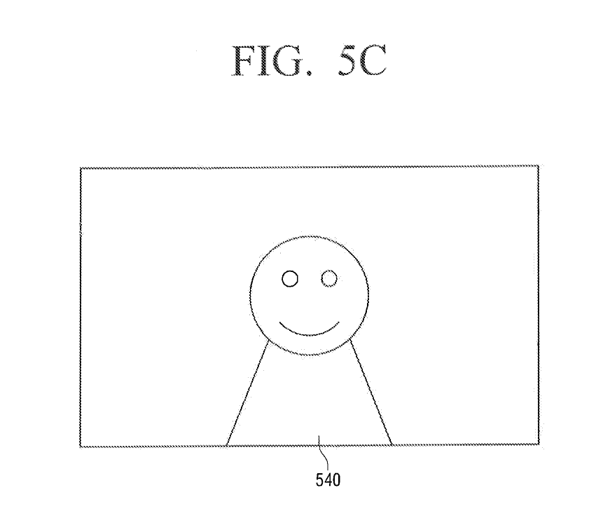

FIGS. 5A to 5C are views to explain a method for processing an image in which a face recognized in a PIP image is synthesized with a face recognized in a main image according to an exemplary embodiment.

If a command to composite the face of a user while the sub image is displayed along with the main image as a PIP image 530, the image photographing apparatus 200 detects the face area 510 of a person to be photographed included in the main image and the face area 535 of a photographer included in the sub image as illustrated in FIG. 5A.

Once the face area 510 of the person to be photographed and the face area 535 of the photographer are detected, the image photographing apparatus 200 moves the PIP image 530 including the face area 535 of the photographer to the face area 510 of the person to be photographed as illustrated in FIG. 5B. In this case, the PIP image 530 may be relocated as the image photographing apparatus 200 moves the PIP image 530 automatically or as a user inputs a drag operation to move the PIP image 530.

Once the PIP image 530 moves to the face area 510 of the person to be photographed, the PIP image 530 is enlarged. Specifically, as the face area 510 of the person to be photographed and synthesized has the different size from the face area 535 of the photographer, the image photographing apparatus 200 adjusts the size and location of the face area 535 of the photographer and the face area 510 of the person to be photographed by enlarging the PIP image 530 including the face area 535 of the photographer.

If the PIP image 530 is enlarged, the image photographing apparatus 200 removes the image excluding the face area 535 of the photographer in the PIP image 530, and displays only the face area 535 of the photographer in the main image. Accordingly, the image photographing apparatus 200 may obtain a new main image 540 in which the face area 510 of the person to be photographed with the face area 535 of the photographer as illustrated in FIG. 5C.

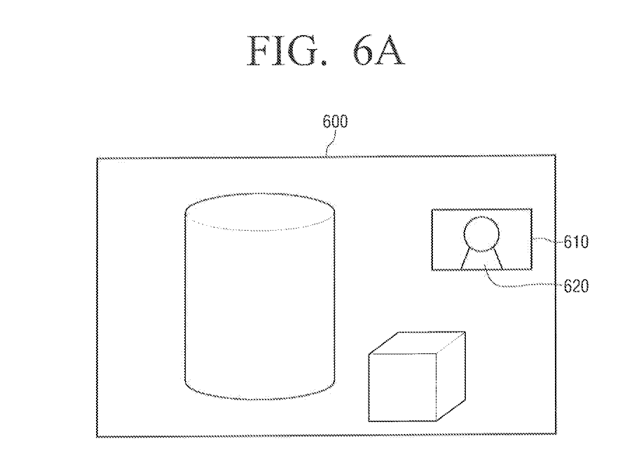

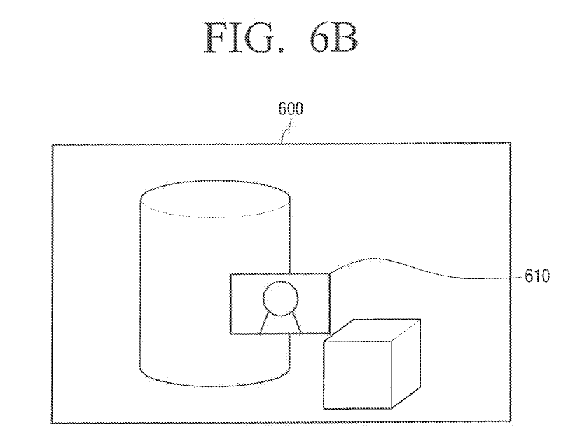

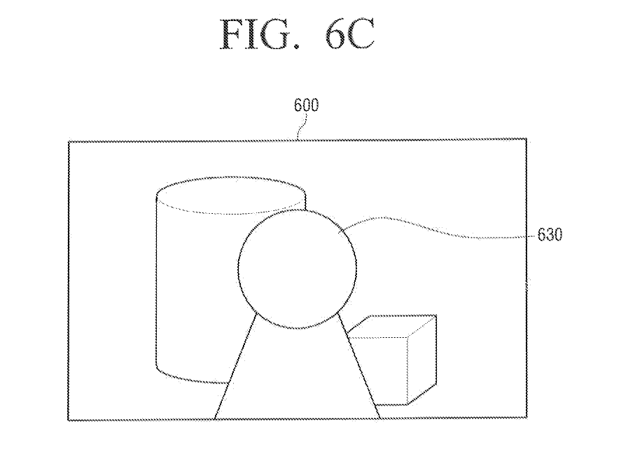

FIGS. 6A to 6C are views to explain a method for processing an image in which a PIP image is synthesized with a main image using a chroma-key composite method according to an exemplary embodiment.

If a chroma-key composite command is input from a user while a main image 600 is displayed along with the sub image having a single-color background as a PIP image 610, the image photographing apparatus 200 detects a subject area 620 excluding the single-color background in the sub image 610 illustrated in FIG. 6A. In this case, the chroma-key composite is a method for disposing a subject, that is, a figure or an object in front of a single-color screen, photographing the subject using an image photographing apparatus, and compositing the subject with a different screen.

If the composite area excluding a single-color background is detected, the image photographing apparatus 200 moves the PIP image 610 including the subject area 620 of a photographer to a specific area of the main image as illustrated in FIG. 6B. In this case, the specific area to which the PIP image 620 is moved may be a center of a screen as illustrated in FIG. 6B or an area designated by a user.

Once the PIP image 610 is moved to the specific area of the main image, the PIP image 610 is enlarged. If the PIP image 610 is enlarged, the image photographing apparatus 200 removes the single-color background area in the PIP image 610 excluding the subject area 620 and displays only the enlarged subject area 630 in the main image. Accordingly, the image photographing apparatus 200 may obtain a new main image in which the enlarged subject area 630 is synthesized with the main image 600 as illustrated in FIG. SC.

Accordingly, a user may obtain various images using the above-mentioned composite method in addition to images photographed through a plurality of lenses.

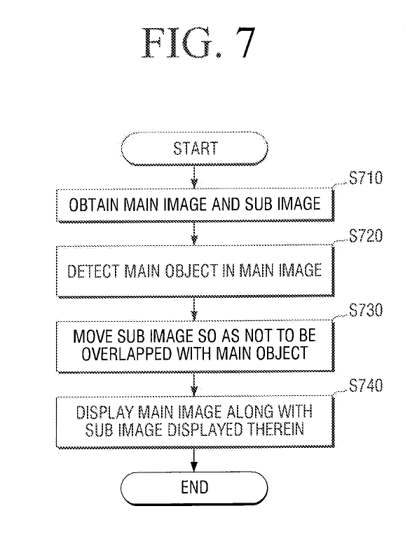

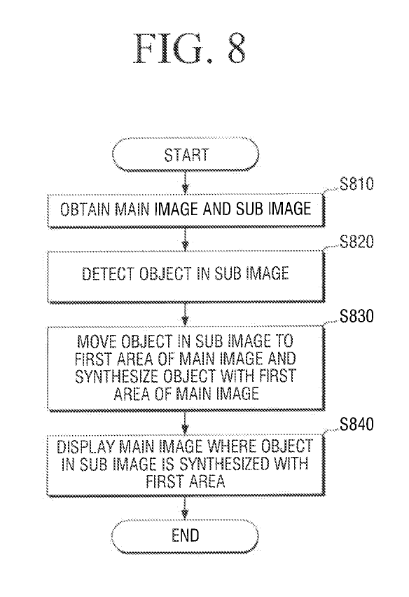

Hereinafter, a method for processing a main image and a sub image according to an exemplary embodiment will be explained with reference to FIGS. 7 and 8.

FIG. 7 is a flowchart to explain a method for processing an image in which a PIP image is relocated so as not to be overlapped with a main object in a main image according to an exemplary embodiment.

Specifically, the image photographing apparatus 100 obtains a main image and a sub image through the first lens unit 110 and the second lens unit 115 respectively (S710). In this case, the main image is an image mainly displayed on the image display unit 140, and the sub image is an image displayed on the main image displayed on the image display unit 140 in the form of a PIP image.

If the main image and the sub image are obtained, the image photographing apparatus 100 detects a main object in the main image (S720). Herein, the main object may be a face area of a person to be photographed or a focus area which is included in the main image. In this case, the face area of the person to be photographed included in the main image is a specific area including a face detected through a known method of recognizing a face, and the focus area is an area of an object or a pattern including an area on which a camera is focused.

Once the main object is detected, the image photographing apparatus 100 determines whether the main object is overlapped with the sub image, and if it is determined that the main object is overlapped with a PIP image which is the sub image, the main object is relocated so as not to be overlapped with the sub image (S730).

After the sub image is relocated, the image photographing apparatus 100 displays the main image along with the relocated sub image on the image display unit 140 (S740).

Accordingly, the sub image is not overlapped with the main object of the main image and thus, a user may view the main image without any interference of the sub image displayed on the display unit.

FIG. 8 is a flowchart to explain a method for processing an image in which an object of a sub image is synthesized with a main image according to an exemplary embodiment.

Specifically, the image photographing apparatus 100 obtains a main image and a sub image through the first lens unit 110 and the second lens unit 115 respectively (S810). In this case, as described above with reference to FIG. 7, the main image Is an image mainly displayed on the image display unit 140, and the sub image is an image displayed on the main image displayed on the image display unit 140 in the form of a PIP image.

If a user's composite command is input after the main image and the sub image are obtained, the image photographing apparatus detects an object included in the sub image (S820). In this case, the object included in the sub image may be a subject area excluding the face area of a photographer included in the sub image or may be a subject area excluding a background from a single-color image. Specifically, if the face of a photographer included in the sub image is synthesized with the face of a person to be photographed included in the main image, the object in the sub image may be an area including the face of the photographer included in the sub image. In addition, in the case of a chroma-key composite, the object in the sub image may be a subject area excluding a single-color background from the sub image

After detecting the object in the sub image, the image photographing apparatus 100 moves the object in the sub image to the first area of the main image and synthesizes the first area of the main image with the object of the sub image (S830). In this case, the first area refers to a specific area of the main image with which the object of the sub image is synthesized. More specifically, if the image photographing apparatus 100 detects the face area of a photographer as an object of the sub image, the image photographing apparatus 100 movers the face area of the photographer to the face area of a person to be photographed in the main image. Subsequently, the image photographing apparatus 100 enlarges the face area of the photographer in the sub image to synthesize it with the face area of the person to be photographed in the main image. In addition, if the image photographing apparatus 100 detects a subject area excluding a single-color background in the sub image in the single-color background, the image photographing apparatus 100 enlarges the subject area and synthesizes it with a specific area of the main image.

After synthesizing the object with the first area of the main image, the image photographing apparatus 100 displays a new image in which the object of the sub image is synthesized with the first area of the main image (S840).

Accordingly, a photographer may obtain various images through synthesis in addition to images photographed through a plurality of lenses.

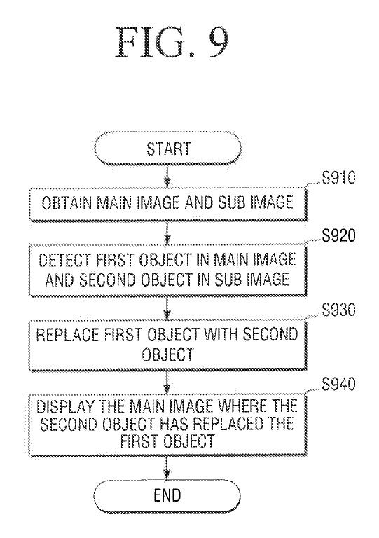

FIG. 9 is a flowchart to explain a method for processing an image in which an object of the main image is replaced with an object of the sub image according to an exemplary embodiment of the present general inventive concept.

Specifically, the image photographing apparatus 100 obtains a main image and a sub image through the first lens unit 110 and the second lens unit 115 respectively (S910). The image photographing apparatus detects an object included in the main image and an object included in the sub image (S920). The object in the main image may be an image of the face of a first person and the object in the sub image may be the image of a face of a second person. The image forming apparatus replaces the detected object in the main image with the detected object in the sub image (S930). As an example of a replacement operation, the image photographic apparatus 100 may move the object of the sub image to the location of the object of the main image and resize the object of the sub image such that it is substantially the same size as the object of the main image. After replacing the object of the main image with the object of the sub image, the image display apparatus 100 displays a new image in which the object of the main image is replaced with the object of the sub image (S840).

In the above description, an image obtained through the first lens unit is assumed to be the main image and an image obtained through the second lens unit is assumed to be the sub image, but this is only an example and the technical feature of the present invention is not limited thereto. For example, an image obtained through the first lens unit may be the sub image and an image obtained through the second lens unit may be the main image according to a user's specific manipulation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable, code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to various exemplary embodiments, the sub image is not overlapped with a main object in the main image and thus, a user may photograph the main image without any interference of the sub image displayed on the display unit.

In addition, as the object of the sub image is synthesized with the main image, the photographer may obtain various images in addition to images photographed through a plurality of lenses.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of processing an image in an image photographing apparatus having a first lens and a second lens, the method comprising:
obtaining a main image and a sub image from the first lens and the second lens respectively;
detecting a main object of the main image;
moving the sub image to a first area of the main image so as not to be overlapped with the main object of the main image; and
displaying the main image and displaying the sub image in the first area of the main image simultaneously.

2. The method of claim 1, wherein the detecting comprises:
recognizing a face of a person to be photographed who is included in the main image obtained from the first lens; and
detecting a specific area including the recognized face as the main object.

3. The method of claim 1, wherein the detecting comprises:
recognizing a focus of the main image obtained from the first lens; and
detecting a specific area which is in focus as the main object.

4. The method of claim 1, wherein the sub image is a Picture-in-Picture (PIP) image.

5. The method of claim 1, wherein the first lens is disposed in a front side of the image photographing apparatus and the second lens is disposed in a back side of the image photographing apparatus.

6. An image photographing apparatus, comprising:
a first lens unit which photographs a main image;
a second lens unit which photographs a sub image;
a detection unit which detects a main object of the main image;
an image conversion unit which moves the sub image to a first area of the main image so as not to be overlapped with the main object of the main image; and
an image display unit which displays the main image and displays the sub image in the first area of the main image simultaneously.

7. The image photographing apparatus of claim 6, wherein the detection unit comprises:
a face recognition unit which recognizes a face of a person to be photographed who is included in the main image obtained from the first lens unit,
wherein the detection unit detects a specific area including the recognized face as the main object of the main image.

8. The image photographing apparatus of claim 6, wherein the detection unit comprises:
a face recognition unit which recognizes a focus of the main image obtained from the first lens unit,
wherein the detection unit detects a specific area which is in focus as the main object of the main image.

9. The image photographing apparatus of claim 6, wherein the sub image is a PIP image.

10. The image photographing apparatus of claim 6, wherein the first lens unit is disposed in a front side of the image photographing apparatus and the second lens unit is disposed in a back side of the image photographing apparatus.

11. A method of processing an image in an image photographing apparatus having a first lens and a second lens, the method comprising:
obtaining a main image and a sub image from the first lens and the second lens respectively;
detecting an object of the sub image;
moving the object of the sub image to a first area of the main image and synthesizing the object of the sub image with the first area of the main image; and
displaying the main image with which the object of the sub image is synthesized.

12. The method of claim 11, wherein the detecting comprises:
recognizing a face of a photographer included in the sub image obtained from the second lens; and
detecting a specific area including the recognized face as the object of the sub image.

13. The method of claim 12, wherein the first area is a specific area including a face of a person to be photographed who is recognized in the main image obtained from the first lens,
wherein the synthesizing comprises synthesizing the face of the photographer with the face of the person to be photographed.

14. The method of claim 11, wherein the sub image has a single-color background, wherein the synthesizing comprises chroma-key synthesizing the object of the sub image with the first area of the main image.

15. The method of claim 11, wherein the sub image is a PIP image.

16. The method of claim 11, wherein the second lens is disposed on an opposite side from the first lens to photograph a photographer of the image photographing apparatus.

17. An image photographing apparatus, comprising:
a first lens unit which photographs a main image;
a second lens unit which photographs a sub image;
a detection unit which detects an object included in the sub image;
an image conversion unit which moves the object of the sub image to a first area of the main image and synthesizes the object of the sub image with the first area of the main image; and
an image display unit which displays the main image with which the object of the sub image is synthesized.

18. The image photographing apparatus of claim 17, wherein the detection unit comprises:
a face recognition unit which recognizes a face of a photographer included in the sub image obtained from the second lens unit;
wherein the detection unit comprises detecting a specific area including the recognized face as the object of the sub image.

19. The image photographing apparatus of claim 18, wherein the first area is a specific area including a face of a person to be photographed who is recognized in the main image obtained from the first lens unit,
wherein the image conversion unit synthesizes the face of the photographer with the face of the person to be photographed.

20. The image photographing apparatus of claim 17, wherein the sub image has a single-color background,
wherein the image conversion unit chroma-key synthesizes the object of the sub image with the first area of the main image.

21. The image photographing apparatus of claim 17, wherein the sub image is a PIP image.

22. The image photographing apparatus of claim 17, wherein the second lens unit is disposed on an opposite side from the first lens unit to photograph a photographer of the image photographing apparatus.

23. A method of processing an image in an image photographing apparatus having a first lens and a second lens, the method comprising:
obtaining a main image and a sub image from the first lens and the second lens respectively;
detecting a first object in the main image and a second object in the sub image;
replacing the first object of the main image with the second object of the sub image; and
displaying the main image in which the second object of the sub image has replaced the first object of the main image.

24. The method of claim 23, wherein the replacing the first object of the main image with the second object of the sub image further comprises:
moving the second object to a location of the first object; and
resizing the second object to a size that is substantially the same as a size of the first object.

25. The method of claim 23, wherein the detecting the first object of the main image and the second object of the sub image further comprises:
detecting an image of a face of a first person as the first object; and
detecting an image of a face of a second person as the second object.

26. The method of claim 23, wherein the first lens and the second lens are disposed on opposite sides of the image photographing apparatus.

27. A method of processing an image in an image photographing apparatus having a first lens and a second lens, the method comprising:
obtaining a main image and a sub image from the first lens and the second lens respectively;
detecting a first object in the main image and a second object in the sub image;
performing at least one of operations of moving the sub image to a first area of the main image so as not to be overlapped with the first object of the main image, moving the second object of the sub image to a second area of the main image and synthesizing the second object of the sub image with the second area of the main image, and replacing the first object of the main image with the second object of the sub image; and
displaying a new image corresponding to the at least one performed operation.
